(19) United States
(12) Patent Application Publication
(10) Pub. No.: US 2015/0114660 A1
(43) Pub. Date: Apr. 30, 2015

(54) Accumulator Manifold

(71) Applicant: Cameron International Corporation, Houston, TX (US)

(72) Inventors: Johnnie Kotrla, Katy, TX (US); Ross Stevenson, Magnolia, TX (US); Jesse J. Garcia, Katy, TX (US)

(73) Assignee: Cameron International Corporation, Houston, TX (US)

(21) Appl. No.: 14/585,048

(22) Filed: Dec. 29, 2014

Related U.S. Application Data
(63) Continuation-in-part of application No. 13/141,318, filed on Jun. 21, 2011.
(60) Provisional application No. 61/158,323, filed on Mar. 6, 2009.

(51) Int. Cl. E21B 33/038; E21B 33/064; F16L 41/02

(52) U.S. Cl. CPC E21B 33/038; F16L 41/021; E21B 33/064
USPC 166/363; 285/133.21

(57) ABSTRACT

A manifold assembly and mineral extraction system including a multi-pressure flange is disclosed that includes a first set of fasteners in a first rectangular pattern for attachment in a first pressure rating and a second set of fasteners in a second rectangular pattern in which the first rectangular pattern is perpendicular to the second rectangular pattern. The second set of fasteners is selectively combinable with the first set of fasteners for attachment in a higher second pressure rating. The flange may include a recess to receive sealing component and a receptacle configured to receive a pipe fitting. Systems and methods including the multi-pressure flange are also disclosed.

### BACKGROUND

This section is intended to introduce the reader to various aspects of art that may be related to various aspects of the present invention, which are described below. This discussion is believed to be helpful in providing the reader with background information to facilitate a better understanding of the various aspects of the present invention. Accordingly, it should be understood that these statements are to be read in this light, and not as admissions of prior art.

Accumulators provide a supply of pressurized working fluid for the control and operation of subsea equipment, such as hydraulic actuators and motors. Typical subsea equipment may include, but is not limited to, blowout preventers that shut off the well bore to secure an oil or gas well from accidental discharges to the environment, valves for the control of flow of oil or gas to the surface or to other subsea locations, or hydraulically actuated connectors and similar devices.

Accumulators are typically divided pressure vessels with a gas section and a useable hydraulic fluid section that operate on a common principle. The principle is to precharge the gas section with an inert, dry, ideal gas (e.g., nitrogen or helium), pressurized to a pressure at or slightly below the anticipated minimum pressure required to operate the subsea equipment. Hydraulic fluid will then be added (or “charged”) to the accumulator in the separate hydraulic fluid section, increasing the pressure of the pressurized gas and the hydraulic fluid to the maximum operating pressure of the control system. The precharge pressure determines the pressure of the very last trickle of fluid from the fluid side of the accumulator, and the charge pressure determines the pressure of the very first trickle of fluid from the fluid side of the accumulator. The discharged fluid between the first and last trickle will be at some pressure between the charge and precharge pressure, depending on the speed and volume of the discharge and the ambient temperature during the discharge event. The hydraulic fluid introduced into the accumulator is therefore stored at the maximum control system operating pressure until the accumulator is discharged for the purpose of doing hydraulic work.

Accumulators generally come in three styles—the bladder type having a balloon type bladder to separate the gas from the fluid, the piston type having a piston sliding up and down a seal bore to separate the fluid from the gas, and the float type with a float providing a partial separation of the fluid from the gas and for closing a valve when the float approaches the bottom to prevent the escape of the precharging gas. A fourth type of accumulator is pressure compensated for water depth and adds the precharge pressure plus the ambient seawater pressure to the working fluid.

The precharge gas can be said to act as a spring that is compressed when the gas section is at its lowest volume/greatest pressure and released when the gas section is at its greatest volume/lowest pressure. Accumulators are typically precharged on the surface in the absence of hydrostatic pressure and subsequently charged with hydraulic fluid on the seabed under full hydrostatic pressure. The surface precharge pressure is limited by the pressure containment and structural design limits of the accumulator vessel under surface ambient conditions. Yet, as accumulators are used in deeper water, the efficiency of conventional accumulators decreases as application of hydrostatic pressure causes the gas to compress, leaving a progressively smaller volume of gas to charge the hydraulic fluid. The gas section must consequently be designed such that the gas still provides enough power to operate the subsea equipment under hydrostatic pressure even as the hydraulic fluid approaches discharge and the gas section is at its greatest volume/lowest pressure.

Typically, accumulators are arranged in banks located proximate the subsea equipment to be operated by the accumulators (e.g., blowout preventors). The accumulators within the bank are in fluid communication via a subsea fluid manifold which is connected to a common hydraulic source of hydraulic fluid. Conventional accumulator manifold systems are tack welded in place (i.e., connected to the accumulators in the accumulator bank). The accumulators are then removed from the accumulator bank and completed with final welds with full quality assurance and quality control testing taking place. After completing the final welding, the manifold is reinstalled in the accumulator bank and connected to a common hydraulic fluid supply source to recharge the hydraulic accumulators due to leakage or use.

One type of high pressure connection used in traditional accumulator manifolds is an autoclave style connection. While autoclave connections provide a higher pressure rating, they may restrict the hydraulic fluid flow from the accumulator. The autoclave connections may be difficult and time-consuming to install and assemble to a leak-free condition. Additionally, the tubing used with the autoclave connections may be more expensive than the tubing used with the conventional connections.

An accumulator manifold that does not require welding and does not use autoclave connections is therefore desirable for simplicity, ease of installation, and economic efficiencies.

### BRIEF DESCRIPTION OF THE DRAWINGS

Various features, aspects, and advantages of the present invention will become better understood when the following detailed description is read with reference to the accompanying figures in which like characters represent like parts throughout the figures, wherein:

FIG. 1 is a block diagram of a mineral extraction system in accordance with an embodiment of the present invention;

FIG. 2 is a block diagram of a BOP and accumulator system in accordance with an embodiment of the present invention;

FIG. 3 is a block diagram of an accumulator and dual pressure flange in accordance with an embodiment of the present invention;

FIGS. 4A and 4B are front and rear perspective views of the dual pressure flange of FIG. 3 in accordance with an embodiment of the present invention;

FIG. 5 is an exploded front perspective view of the dual pressure flange and a seal component that may be used with the dual pressure flange in accordance with an embodiment of the present invention;

FIG. 6 a front perspective view of the assembled dual pressure flange and seal component in accordance with an embodiment of the present invention;

FIG. 7 depicts a front view of the dual pressure flange in accordance with an embodiment of the present invention;

FIG. 8 depicts a cross-section of the assembled dual pressure flange and seal component taken along line 7-7 of FIG. 7 in accordance with an embodiment of the present invention;

FIGS. 9A and 9B depict a front and rear perspective view respectively of the dual pressure flange in a low pressure configuration in accordance with an embodiment of the present invention;

FIG. 10 is a cross-sectional view of the dual pressure flange taken along line 7-7 of FIG. 7 in accordance with an alternate embodiment of the present invention;

FIG. 11 depicts a front view of the dual pressure flange in accordance with an alternate embodiment of the present invention; and

FIG. 12 depicts a perspective view of an accumulator manifold including non-welded connections.

### DETAILED DESCRIPTION

One or more specific embodiments of the present invention will be described below. These described embodiments are only exemplary of the present invention. Additionally, in an effort to provide a concise description of these exemplary embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present invention, the articles “a,” “an,” “the,” and “said” are intended to mean that there are one or more of the elements. The terms “comprising,” “including,” and “having” are intended to be inclusive and mean that there may be additional elements other than the listed elements. Moreover, the use of “top,” “bottom,” “above,” “below,” and variations of these terms is made for convenience, but does not require any particular orientation of the components.

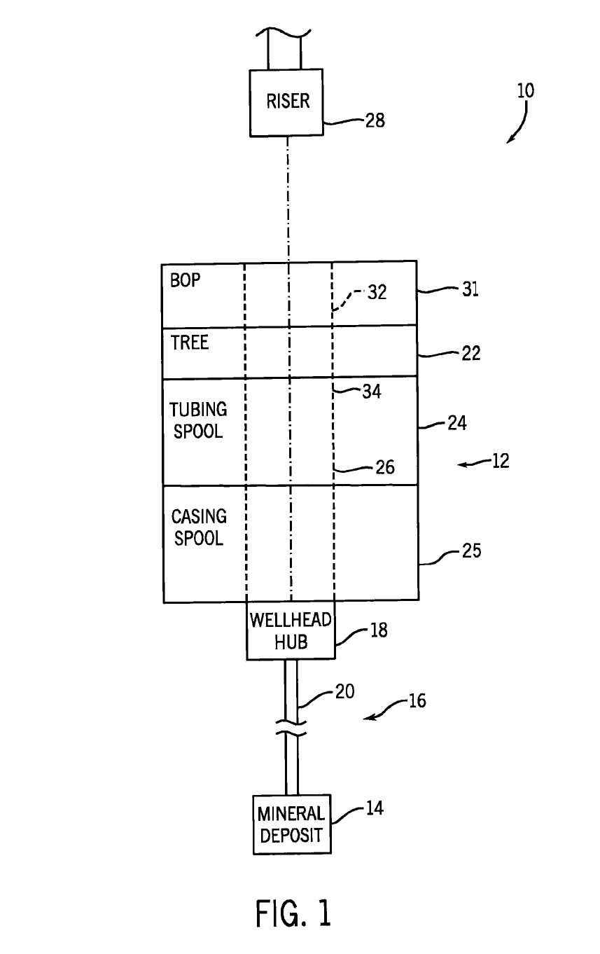

FIG. 1 is an illustration of an exemplary mineral extraction system 10. The illustrated mineral extraction system 10 can be configured to extract various minerals and natural resources, including hydrocarbons (e.g., oil and/or natural gas), or configured to inject substances into the earth. In some embodiments, the mineral extraction system 10 is land-based (e.g., a surface system) or subsea (e.g., a subsea system).

The system 10 typically includes multiple components that control and regulate activities and conditions associated with the well 14. For example, the system 10 typically includes bodies, valves and seals that route produced minerals from the well 14, provide for regulating pressure in the well 14, and provide for the injection of chemicals into the well 14. In the illustrated embodiment, the system 10 includes a production tree 22, a tubing head 24, a casing head 25, and a hanger 26 (e.g., a tubing hanger or a casing hanger). The system 10 may include other devices that are coupled to the wellhead assembly 12, and devices that are used to assemble and control various components of the wellhead assembly 12. For example, in the illustrated embodiment, the system 10 includes a riser 28 coupled to a floating rig 36.

The production tree 22 generally includes a variety of flow paths (e.g., bores), valves, fittings, and controls for operating the well 14. For instance, the production tree 22 may include a frame that is disposed about a tree body, a flow-loop, actuators, and valves. Further, the production tree 22 may provide fluid communication with the well 14. For example, the production tree 22 includes a tree bore 32. The production tree bore 32 provides for completion and workover procedures, such as the insertion of tools into the well 14, the injection of various chemicals into the well 14, and the like. Further, minerals extracted from the well 14, such as oil and natural gas, may be regulated and routed via the production tree 22. For instance, the production tree 12 may be coupled to a jumper or a flowline that is tied back to other components, such as a production manifold. Accordingly, produced minerals flow from the well 14 to the production manifold via the wellhead assembly 12 and/or the production tree 22 before being routed to shipping or storage facilities. A blowout preventer 31 may also be included during drilling or workover operations, either as a part of the production tree 22 or as a separate device. The blowout preventor 31 may consist of a variety of valves, fittings and controls to prevent oil, gas, or other fluid from exiting the well in the event of an unintentional release of pressure or an unanticipated overpressure condition. Two or more blowout preventors may be stacked together.

In the illustrated embodiment, the production tree 22 is landed on the tubing head 24. The tubing head 24 includes a tubing head bore 34. The tubing head bore 34 sealably connects (e.g., enables fluid communication between) the tree bore 32 and the well 16. Thus, the tubing head bore 34 may provide access to the well bore 20 for various completion and workover procedures. For example, components can be run down to the wellhead assembly 12 and disposed in the tubing spool bore 34 to seal-off the well bore 20, to inject chemicals down-hole, to suspend tools down-hole, to retrieve tools downhole, and the like.

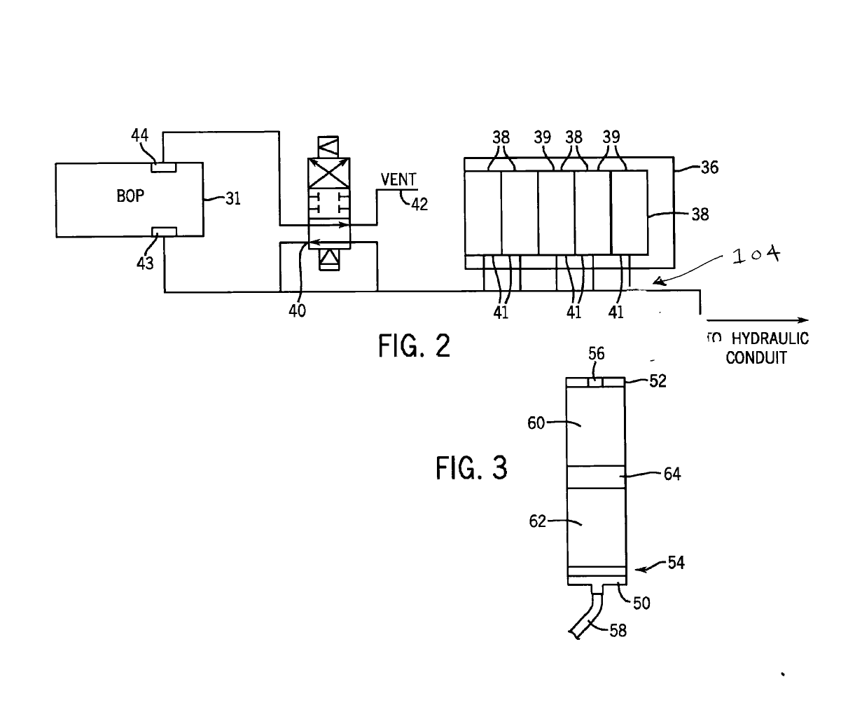

The blowout preventor 31 may be hydraulically operated and may close the wellhead assembly 12 or seal off various components of the wellhead assembly 12. To enable hydraulic operation of the blowout preventor 31, the blowout preventor 31 may be coupled to a source of hydraulic pressure, e.g., pressurized hydraulic fluid. FIG. 2 is a block diagram of the blowout preventor 31 and an accumulator bank 36 in accordance with an embodiment of the present invention. The accumulator bank 36 may include one or more accumulators 38. The accumulator bank 36 may house the accumulators 38, providing easier installation and operation of the accumulators 38. In some embodiments, a group of accumulators 38 may also be referred to as a “module” or a “rack.” A control valve 40 may also be included to control the blowout preventor 31 and the accumulator bank 36. The control valve 40 may also include a vent 42. The blowout preventor 31 may include an open port 43 and a close port 44. The accumulators 38 may provide pressurized hydraulic fluid to either the open port 43 or close port 44, as determined by the control valve 40, to open or close the blowout preventor 31.

The accumulators 38 output pressurized hydraulic fluid to the blowout preventor 31. Thus, the accumulators 38 may be referred to as having a gas end 39 and a liquid end 41. As shown in FIG. 2, the liquid end 41 may be coupled to the control valve 40 and to a hydraulic conduit. The accumulators 38 provide pressurized hydraulic fluid to the blowout preventor 31 to enable operation of the blowout preventor via hydraulic pressure. In some embodiments, the blowout preventor 31 (i.e., blowout preventor stack) may include anywhere from about 10 to over 100 accumulators, depending on size, rack configurations, blowout preventor size, rated water depth, the number of hydraulic circuits, and other factors.

Once the blowout preventor 31 is coupled to the wellhead assembly 12, the accumulators 36 may provide charging of the blowout preventor 31 with the hydraulic fluid from a liquid end 41 of the accumulator. In some embodiments, the working hydraulic pressure of the control system for the blowout preventor 31 may be about 5,000 psi. However, in a subsea installation, the precharge pressure of the gas may be higher than the maximum system pressure to overcome the subsea hydrostatic pressure (approximately 0.5 psi/ft of water depth) and the minimum system pressure required to operate the blowout preventor 31. In such an embodiment, the gas end 39 of the accumulators 38 is typically capable of a higher rated pressure than the liquid end 41. According to industry standards, the pressure rating of each accumulator 38 may be determined as the pressure rating of its lowest rated connection. Thus, if a specific pressure rating is desired, the lowest rated end connection must be selected to achieve the desired pressure rating.

While conventional accumulators may be rated from about 5,000 psi to about 6,000 psi (e.g., the pressure rating for the accumulator matches the pressure rating of the gas end 39), deeper subsea wellhead assemblies may include higher pressures. The present disclose provides a manifold 104 comprising one or more multi-pressure (e.g., dual pressure) flanges capable of supporting pressure ratings for high pressure subsea installations (e.g., at least about 15,000 psi) and pressure ratings for low pressure installations (e.g., at least about 6,000 psi). As used herein, the terms “high pressure” and “low pressure” are relative terms used to refer to a relationship between two pressures.

FIG. 3 depicts a block diagram of a multi-pressure flange 50 and an accumulator 38 which can be used with the manifold 104 presently disclosed. In the following discussion, the flange 50 is generally described as a dual-pressure flange 50. However, various embodiments of the flange 50 may be a tri-pressure flange, a quad-pressure flange, or some other multi-pressure flange. The accumulator 38 includes a gas end 52 and a liquid connection 54. The accumulator 38 may be precharged with gas. For example, the accumulators 38 of a bank 36 may each be precharged with gas on the surface before installation, such as via a valve 56. The liquid connection 54 may be connected to the blowout preventor 31 (or other hydraulic component) of a wellhead assembly 12 via a pipe 58.

The accumulator 38 may include a plurality of chambers, such chambers 60 and 62, for receiving gases and fluids. For example, in one embodiment the chamber 60 may be precharged with gas through the valve 56, and may output pressurized hydraulic liquid from the chamber 62 through the connection 54.

The gas end 52 and liquid connection 54 may be separated by an energy storage and transfer device 64. In some embodiments, the energy storage and transfer device 64 may be a piston, an elastomeric bladder, or any other suitable device or combination thereof. The energy storage and transfer device 64 may isolate the chambers of the accumulator 38, such as isolating chamber 60 from 62. The energy transfer and storage device 64 transfers energy (such as from the pressurized gas from the chamber 60) and controls flow of the hydraulic fluid in and out of the accumulator through the connection 54.

As described above, in certain installations, it may be desirable to have a specific pressure rating for the gas end 52 and/or the connection 54. The dual pressure flange 50 may couple to the connection 54 of the accumulator 38 to provide the desired pressure rating and allow connection of the liquid line 58. For example, as described further below, the dual pressure flange 50 provides connection and sealing capability to enable use in a deep water subsea installation of the accumulator 38, such as for pressure ratings of at least about 10,000 psi. Further, the dual pressure flange 50 provides connection and sealing capability to enable use in conventional subsea installations, such as for pressure ratings of at least about 6,000 psi.

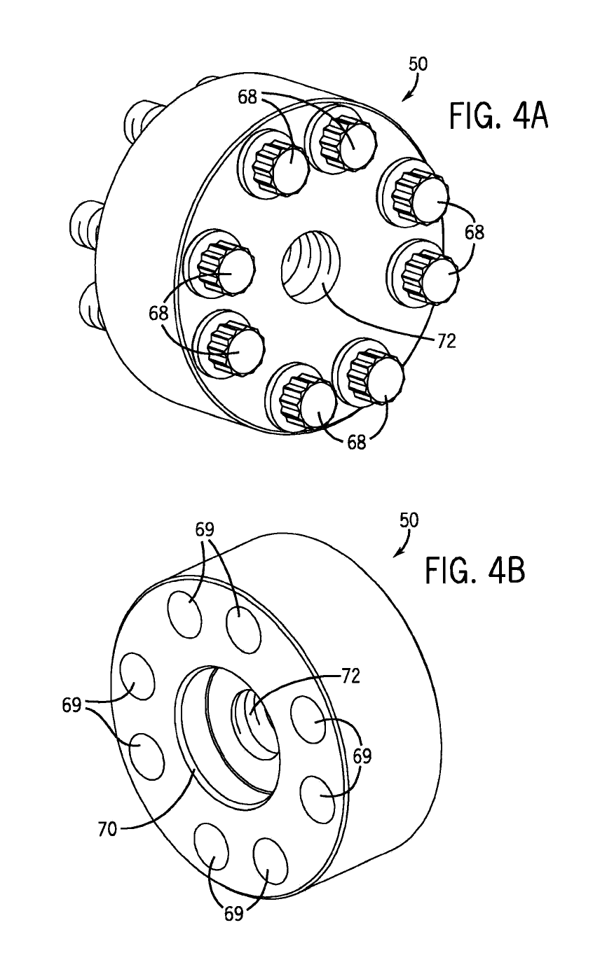

FIGS. 4A and 4B depict a front perspective view and a rear perspective view respectively of the dual pressure flange 50 in accordance with an embodiment of the present invention. As shown in FIG. 4A, the dual pressure flange 50 includes eight fasteners, such as attaching bolts 68, arranged in two rectangular four-bolt patterns, as described further below. In some embodiments, the fasteners may be threaded to enable coupling to the connection 54 of the accumulator 38. As shown in FIG. 4B, the bolts 68 are removed from the flange 50 to illustrate a plurality of holes 69 (e.g., threaded receptacles) that receive the bolts 68. The holes 69 are also arranged in two rectangular four-hole patterns, as described further below.

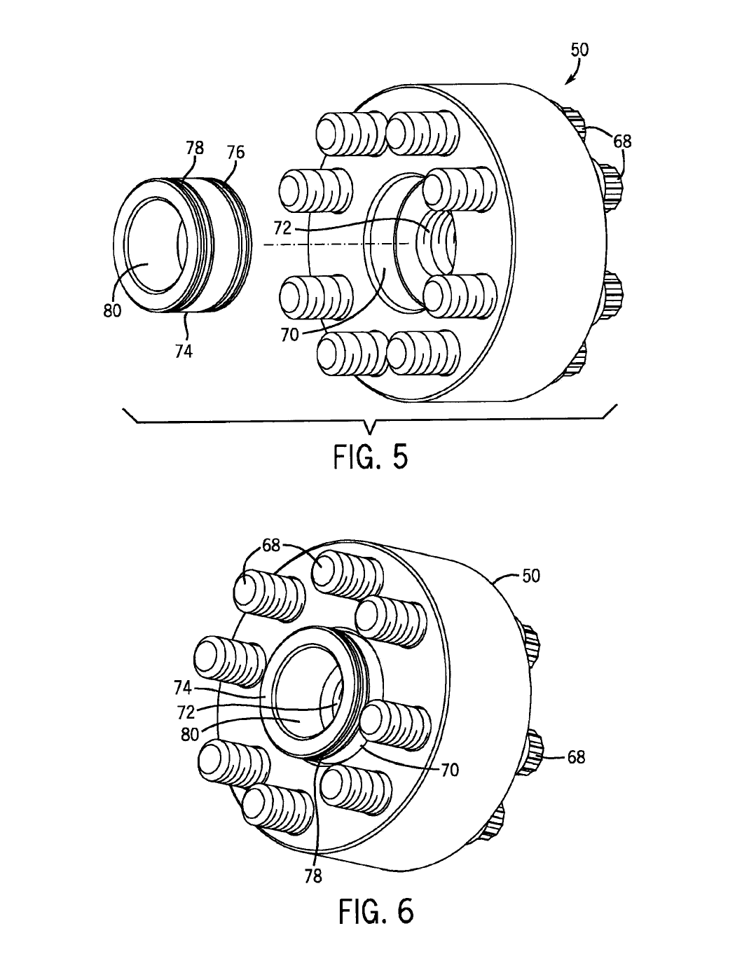

The dual pressure flange 50 also includes a receptacle 70 configured to receive a sealing mechanism, such as the seal component described in FIG. 5. Additionally, the dual pressure flange 50 includes a threaded connection 72 that may receive a fitting, pipe, or other component to transport fluid through the flange 50 into and out of the accumulator 38. For example, in one embodiment, the threaded connection 72 may include National Pipe Thread (NPT) threads. The flange 50 may comprise or consist essentially of steel or any other suitable alloy. In one embodiment, the flange 50 may consist essentially of type 316 stainless steel.

FIG. 5 depicts a perspective view of a sealing component, such as a seal sub 74, and the dual pressure flange 50 in accordance with an embodiment of the present invention. The seal sub 74 may be used to aid in sealing the dual pressure flange 50 when installed on the accumulator 38. The seal sub 74 may include a first seal 76 configured to seal against the flange 50 (such as by against the walls of the receptacle 70) and a second seal 78 configured to seal against the connection 54 on the accumulator 38 when the sub seal 74 is installed. In some embodiments, the first seal 76 and second seal 78 may comprise o-rings. The seal sub 74 includes a hole 80 through which gas or fluid may flow though the flange 50 and into and out of the accumulator 38. Additionally, the threaded connection 72 and hole 80 may provide increased flow capacity over conventional “autoclave” connections, resulting in lower response times for the blowout preventor 31.

FIG. 6 depicts a rear perspective view of the assembled dual pressure flange 50 and the seal sub 74 in accordance with an embodiment of the present invention. As shown in FIG. 6, the seal sub 74 inserts into the receptacle 70 such that the first seal 76 engages the walls of the receptacle 70. The second seal 78 remains outside the receptacle 70 to provide sealing against a connection when the flange 50 installed. The seal sub 74 “floats” between the flange 50 and the connection 54 of the accumulator 38. For repair or replacement, the seal sub 74 may be removed from the flange 50.

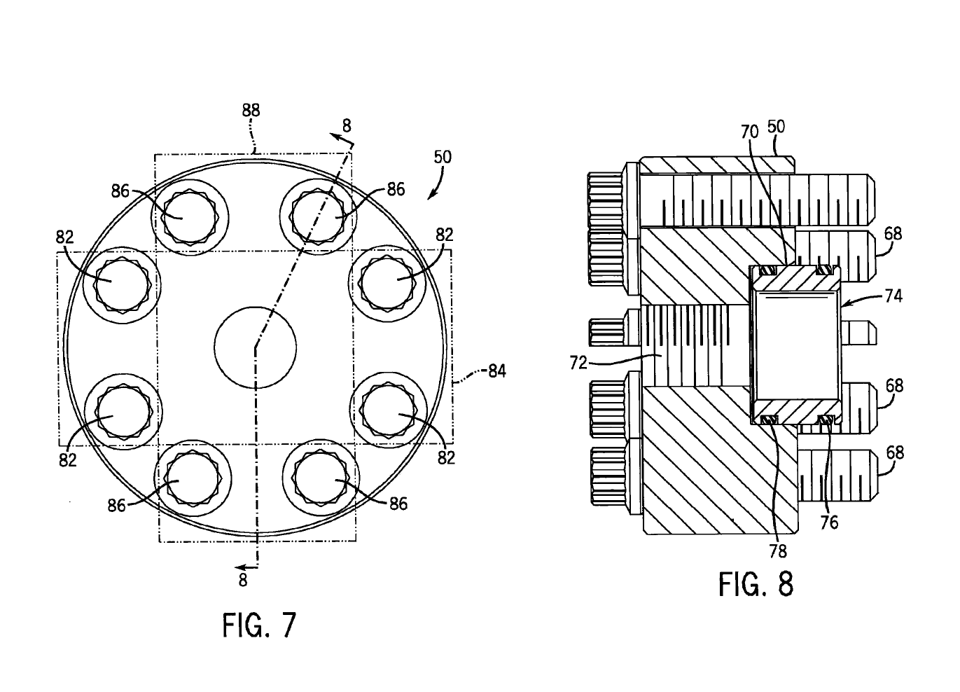

FIG. 7 depicts a front view of the dual pressure flange in accordance with an embodiment of the present invention. As seen more clearly in FIG. 7, when assembled, the threaded connection 72 of the flange 50 and the hole 80 of the seal sub 74 align to allow insertion of a pipe fitting, or other component to allow fluid or gas flow in and out of the accumulator 38. As described above, the dual pressure flange 50 includes eight attaching bolts 68 arranged in two rectangular four-bolt patterns. The rectangular patterns may be displaced at 90° to each other. For example, as shown in FIG. 7, a first group 82 of four bolts may be arranged in a first rectangular pattern 84, and a second group 86 of four bolts may be arranged in a second rectangular pattern 88. As described further below, when using the dual pressure flange 50 in a low-pressure configuration (e.g., at least about 6,000 psi) such that only four bolts are used to secure the flange to a connection of an accumulator, the two rectangular patterns 84 and 88 allow easier orientation of the flange 50 during installation onto a connection. For example, when installing with four bolts, either one of the two rectangular patterns 84 and 88 may be aligned with the respective mating surface for the flange 50. As shown in FIG. 7, the first group 82 of four bolts and the second group 86 of four bolts are not uniformly spaced between the first rectangular pattern 84 and the second rectangular pattern 88.

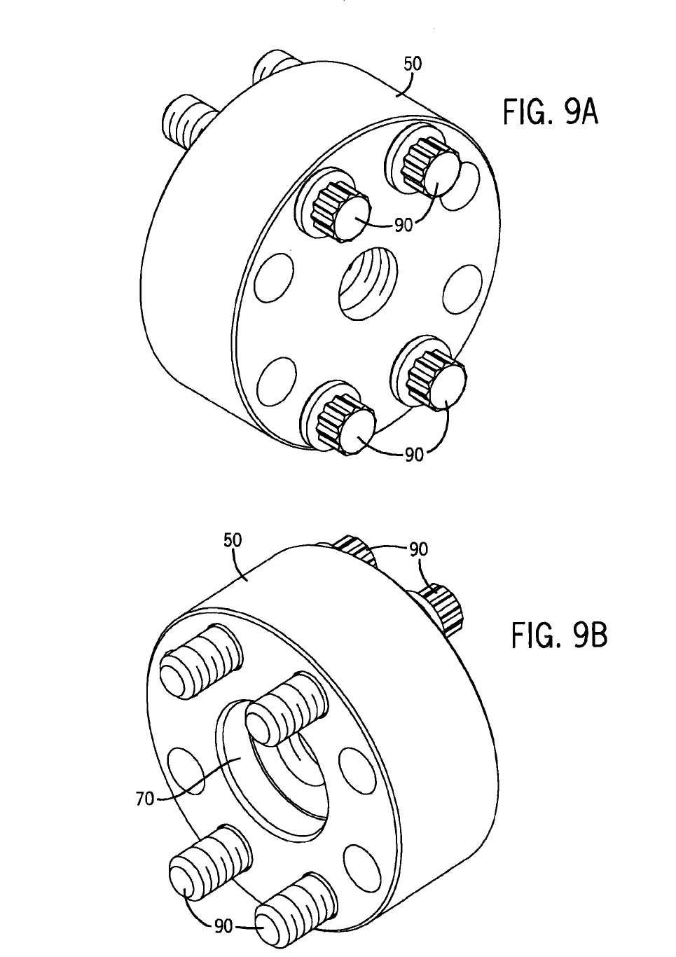

FIG. 8 is a cross-sectional view of the dual pressure flange 50 taken along line 7-7 of FIG. 7 in accordance with an embodiment of the present invention. As illustrated in FIG. 8, the flange 50 receives the seal sub 74 such that the seal sub 74 (and the included seals 76 and 78) provides an enhanced sealing mechanism against the connection of the accumulator (as opposed to the sealing provided by a face seal of the flange 50). Additionally, because of the positioning of the seal sub, i.e., “floating” in the flange 50 and the connection 54 of the accumulator 38, the integrity of the seal between the flange 50 and the connection 54 is not dependent on the makeup torque on the attaching bolts 68 when installing the flange 50. Further, use of the seal sub 74 may eliminate machining requirements for the face of the flange 50. However, in a low pressure configuration, as described below in FIGS. 9A and 9B, the seal sub 74 may be omitted from the installed flange 50.

FIGS. 9A and 9B depict a front and rear perspective view respectively of the dual pressure flange 50 in a low pressure configuration in accordance with an embodiment of the present invention. In a low pressure configuration, the flange 50 may include four attaching bolts 90 arranged in one of the rectangular patterns 84 or 88. The four attaching bolts 90 may be used to secure the flange as a low pressure (e.g., at least about 6,000 psi) connection.

In other embodiments, eight attaching bolts may remain in the flange 50 in the low pressure configuration, so that the flange 50 may be more easily oriented during installation to ensure that one of the two rectangular patterns 84 or 88 of the bolts 90 couple with the low pressure connection on the accumulator 38. Advantageously, the low pressure configuration of the dual pressure flange 50 allows the flange 50 to function as a conventional Society of Automotive Engineers (SAE) Code 62 flange. In this configuration, the flange 50 may be usable with any equipment configured to use or connect via an SAE Code 62 flange. In such an embodiment, the dual pressure flange 50 may be used with or without the seal sub 74. In some embodiments, the sealing function may be provided by a face seal of the flange 50 sealing against the connection 54. However, in contrast to the embodiments discussed above, use of face seal makes the sealing capability of the flange 50 sensitive to the makeup torque on the bolts 90 when installing the flange, and may also make the flange 50 susceptible to pressure induced face flange separation. A face seal may also be used in a high pressure flange configuration that uses eight bolts in both rectangular patterns 84 and 88 to couple the flange 50.

The flange 50 may be coupled to a family of different components to achieve different pressure ratings. For example, the low pressure configuration, e.g., using four bolts of the flange 50, may be used to couple the flange 50 to a first component to achieve a first pressure rating. Similarly, a higher pressure configuration, e.g., using eight bolts of the flange 50, may be used to couple the flange 50 to a second component to achieve a second pressure rating.

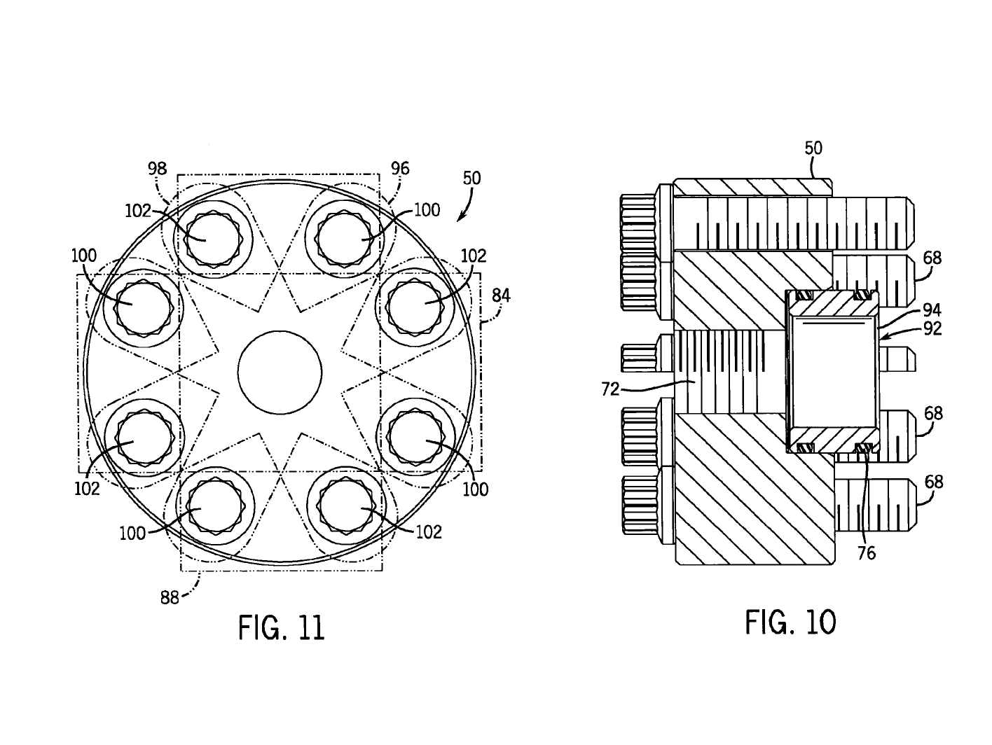

FIG. 10 is a cross-sectional view of the dual pressure flange 50 taken along line 7-7 of FIG. 7 in accordance with an alternate embodiment of the present invention. In the embodiment depicts in FIG. 10, the dual pressure flange 50 may be designed and manufactured without a cavity for the seal sub 74. Instead, the dual pressure flange 50 may include an integral seal sub nose 92. The integral seal sub nose 92 may include an external groove 94 configured to receive a seal, such as an o-ring. The integral seal sub nose 92 is configured to penetrate the seal sub sealing counterbore and may eliminate a potential leak path between the inner diameter of the flange 50 and the outer diameter of the seal sub 74. Further, the integral seal sub nose 92 may eliminate the “floating” capability of the seal, e.g., o-ring, disposed in the external groove 94.

FIG. 11 depicts a front view of the dual pressure flange in accordance with an alternate embodiment of the present invention. The embodiment depicts in FIG. 11 includes additional bolt patterns, e.g., a first cross pattern 96 and a second cross pattern 98, that may be used in sealing the flange 50. The first cross pattern may include four bolts 100, wherein each pair of the four bolts 100 includes two bolts radially across from each other, as shown in FIG. 11. Similarly, the second cross pattern 98 may include four bolts 102, wherein each pair of the four bolts 102 also includes two bolts radially across from each other. When installing the flange 50 in either a four-bolt or eight-bolt, any combination of first rectangular pattern 84, second rectangular pattern 88, first cross pattern 96, and second cross pattern 98 may be used to achieve a desired pressure rating and withstand the exerted pressure loads.

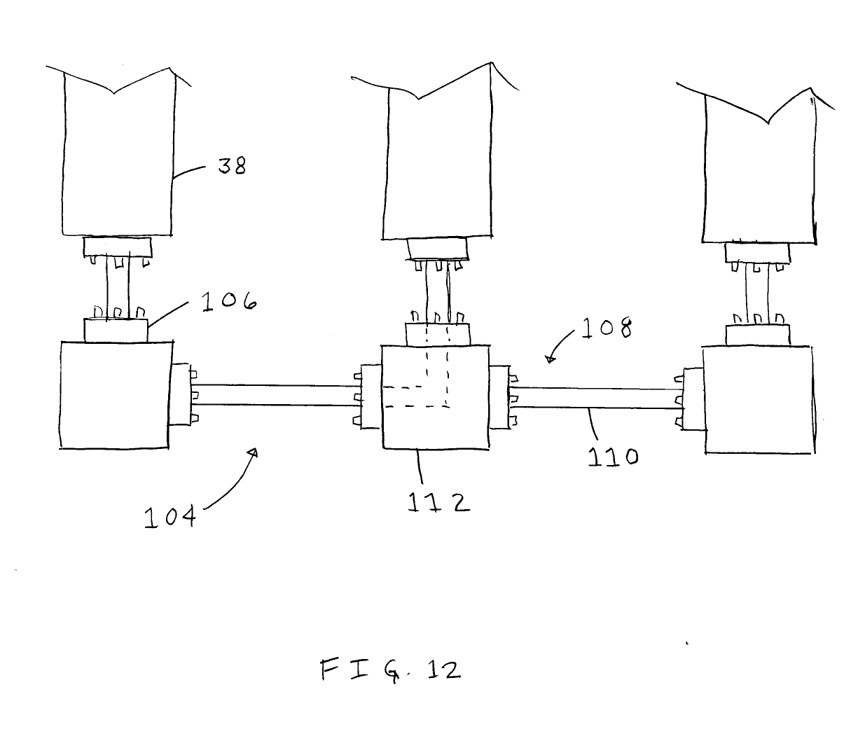

FIG. 12 depicts an accumulator manifold 104 including a dual pressure flange 106 as disclosed in FIG. 4A above. Alternative dual pressure flange embodiments as disclosed in FIGS. 5-11 can also be incorporated into the manifold.

The accumulator manifold 104 is coupled to a common hydraulic source (not shown) and provides fluid communication to the accumulators 38 arranged on the accumulator manifold 104. The accumulator manifold 104 comprises a frame 108 composed of pipe segments 110. The pipe segments 110 are coupled to spools 112 disposed along the frame 108. The spools 112 comprise upper, lower and lateral surfaces. The connection between each pipe segment 110 and each spool 112 is established via a dual pressure flange 106.

As illustrated, each spool 112 is coupled to two pipe segments 110 on its lateral surfaces and one pipe segment 110 on its upper surface. The pipe segments 110 extending from the spool 112 lateral surfaces are in fluid communication with adjacent spools. The pipe segments 110 extending from the spool 112 upper surface are in fluid communication with accumulators 38 positioned above the respective spools 112. The accumulators 38 are coupled to the spools 112 by way of the dual pressure flanges 106. In alternative embodiments, a spool 112 may comprise one or more pipe segment 110 connections on any of its upper, lower and/or side surfaces.

Accumulator manifold 104 does not require welding and does not use autoclave connections and is desirable for simplicity, ease of installation, and economic efficiencies.

While the invention may be susceptible to various modifications and alternative forms, specific embodiments have been shown by way of example in the drawings and have been described in detail herein. However, it should be understood that the invention is not intended to be limited to the particular forms disclosed. Rather, the invention is to cover all modifications, equivalents, and alternatives falling within the spirit and scope of the invention as defined by the following appended claims.

1. An apparatus for coupling a fluid supply to one or more components, the apparatus comprising:
a manifold frame comprising:
a spool connected to each component;
a pipe segment connected between each spool, providing for fluid communication between each spool;
wherein the interface between each spool, component, and pipe segment includes a flange comprising:
a first set of fastener holes in a first pattern for attachment of fasteners for a first pressure rating;
a second set of fastener holes in a second pattern for selective attachment of fasteners for a second pressure rating that is higher than the first pressure rating;
a recess configured to receive a sealing component; and
a receptacle configured to receive a pipe fitting.

2. The apparatus of claim 1, wherein each of the first and second set of fastener holes comprises four holes.

3. The apparatus of claim 1, wherein the each of the first and second set of fastener holes comprises eight holes.

4. The apparatus of claim 1, wherein the first pattern comprises a first rectangular pattern or a first cross-shaped pattern and the second pattern comprises a second rectangular pattern or a second cross-shaped pattern.

5. The apparatus of claim 4, wherein the first pattern comprises the first rectangular pattern and the second pattern comprises the second rectangular pattern.

6. The apparatus of claim 4, wherein the first pattern comprises the first cross-shaped pattern and the second pattern comprises the second cross-shaped pattern.

7. The apparatus of claim 1, wherein the second set of fasteners is selectively combinable with the first set of fasteners in a third pattern for attachment in a third pressure rating.

8. The apparatus of claim 1, wherein:
the first set of fastener holes comprise a first spacing within the first pattern;
the second set of fastener holes comprise a second spacing within the second pattern; and
the first and second fastener holes combine to comprise a third spacing between the first and second patterns, and the third fastener spacing being less than both the first fastener spacing and the second fastener spacing.

9. The apparatus of claim 1, wherein the sealing component comprises a cylindrical sealing component comprising one or more seals, and the sealing component is configured to float lengthwise along the recess.

10. The apparatus of claim 9, wherein the sealing component comprises a hole configured to align with the receptacle.

11. The apparatus of claim 9, wherein the one or more seals comprise o-rings.

12. The apparatus of claim 1, wherein the first set of fasteners and the second set of fasteners comprise bolts.

13. The apparatus of claim 1, wherein the first pressure rating is at least 5,000 psi and the second pressure rating is at least 10,000 psi.

14. A mineral extraction system, comprising:
a blowout preventor stack;
an accumulator bank coupled to the blowout preventor stack, the accumulator bank comprising a plurality of accumulators in fluid communication via a manifold system;
a flange coupling each accumulator to the manifold system, wherein the flange comprises:
a first set of fastener holes in a first pattern for attachment of fasteners for a first pressure rating;
a second set of fastener holes in a second pattern for selective attachment of fasteners for a second pressure rating that is higher than the first pressure rating;
a recess configured to receive a sealing component; and
a receptacle configured to receive a pipe fitting.

15. The system of claim 14, wherein the first set of fasteners comprises four fasteners and the second set of fasteners comprises four fasteners.

16. The system of claim 14, wherein the first set of fasteners comprises eight fasteners and the second set of fasteners comprises eight fasteners.

17. The system of claim 14, wherein the first pattern comprises a first rectangular pattern or a first cross-shaped pattern and the second pattern comprises a second rectangular pattern or a second cross-shaped pattern.

18. The system of claim 14, wherein the second set of fasteners is selectively combinable with the first set of fasteners in a third pattern for attachment in a second pressure rating.

19. The system of claim 14, wherein the sealing component comprises a cylindrical sealing component comprising one or more seals, and the sealing component is configured to float lengthwise along the recess.

20. The system of claim 19, wherein the sealing component comprises a hole configured to align with the receptacle.

21. The system of claim 19, wherein the one or more seals comprise o-rings.
